(19) United States
(12) Patent Application Publication
(10) Pub. No.: US 2005/0038574 A1
(43) Pub. Date: Feb. 17, 2005

(54) Identification system for verifying an authorization for access to an object, or use of an object, in particular a motor vehicle

(76) Inventors: Janos Gila, Modling (AT); Klaus Hofbeck, Neumarkt (DE); Wolfgang Konrad, Modling (AT); Birgit Rosel, Regensburg (DE)

Correspondence Address: Andreas Grubert;Baker Botts L.L.P., One Shell Plaza, 910 Louisiana, Houston, TX, 77002-4995, US

(21) Appl. No.: 10/938,152

(22) Filed: Sep. 10, 2004

Related U.S. Application Data
(63) Continuation of application No. PCT/DE03/00718, filed on Mar. 3, 2003.

(30) Foreign Application Priority Data
Mar. 21, 2002 (DE) 10212648.8

(51) Int. Cl. G06F 17/00

(52) U.S. Cl. 701/2; 701/1

(57) ABSTRACT

A portable encoder transmits a response signal, which contains code information that is specific to the encoder (2). The code information contained in the received response signal is compared with reference code information in a receiving unit (4), which is located in the object and is connected to an evaluation unit (9). In addition, both the distance of the encoder (2) from the receiving unit (4) and the receiving level of the response signal are measured on the object side and the position of the encoder (2) is calculated from the measurements. This permits a differentiation to be made between the exterior and interior regarding the position of the encoder (2). Access is released and authorization is granted, only if the position of the encoder (2) is identified as permissible.

### CROSS REFERENCE TO RELATED APPLICATION

This application is a continuation of copending International Application No. PCT/DE03/00718 filed Mar. 3, 2003 which designates the United States, and claims priority to German application no. 102 12 648.8 filed Mar. 21, 2002.

### TECHNICAL FIELD OF THE INVENTION

The invention relates to an identification system for verifying an authorization for access to an object, or for use of an object, in particular of a motor vehicle.

### DESCRIPTION OF THE RELATED ART

Radio-based identification systems, also known as RFID “radio frequency identification” systems, are being increasingly used, for example, as a replacement for mechanical key systems, for access protection for computers or possibly in automatic payment systems. An RFID system consists of an electronic identification tag (hereinafter referred to as a code transmitter or transponder) which is also known as an electronic key, RFID tag, ID transmitter or ID card which the user carries with him or which is disposed on an object to be identified. The code transmitter is provided with a characteristic code (code information). The code transmitter is generally interrogated for this code via an object-side base station (hereinafter referred to as object-side transceiver unit) and the code is then authenticated or verified. The code can also be transmitted from the code transmitter to the object in response to other triggering mechanisms.

Various radio-based transmission technologies are possible or usual: LF systems in the 100-300 kHz range, RF or HF systems at 433 MHz (315 MHz) or 867 MHz, and high-frequency microwave systems mainly operating at frequencies of 2.4 GHz, 5.8 GHz, 9.5 GHz or 24 GHz.

With code transmitters, a distinction is drawn between active and passive identification. Passive identification means that the code transmitter can be continuously interrogated via the transceiver unit without any action on the part of the user. If the code transmitter is within a certain distance of the transceiver unit, communication between transceiver unit and code transmitter takes place automatically or e.g. triggered by manual actuation of a switching device, such as operation of a door handle by the user. The limiting factor for the range is generally the path loss. The transmission of the interrogation signal and the response signal triggered thereby is also known as a challenge-response dialog.

In an active identification system, on the other hand, communication is actively initiated by the user from the code transmitter, the user therefore generally having first to actuate the code transmitter manually and then, for example, additionally operate the door handle in order to open the door. The user thus has to perform more manual actions. For reasons of greater user convenience, passive identification systems are therefore being increasingly used.

The disadvantage of identification systems of this kind is that, for one thing, a “hacker” can unauthorizedly and undesirably monitor the transmission channel unnoticed and at basically any point in time. By means of suitable equipment it is therefore normally possible for a hacker to gain unauthorized access to the code and therefore defeat the actually intended protection function.

In a known identification system (DE 198 36 957 C1 or WO 01/89887 A1) it is attempted to increase security against unauthorized use or unauthorized access resulting from monitoring of the challenge/response dialog. In this case a first interrogation signal is transmitted by the base station, the receive power of said signal being measured at the code transmitter. A second interrogation signal is then transmitted under changed transmitting conditions, the receive power of which second signal is likewise measured at the code transmitter. Only if the receive powers are different is the code information in the response signal evaluated.

With this identification system, at least two challenge/response dialogs must always take place before access or use can be granted. Even if this increases security against unauthorized use or unauthorized access, the multiple dialog is at the expense of optimally rapid access. For the challenge/response dialog is not supposed to interfere with the user's normal procedure.

On the other hand, the disadvantage of LF and RF identification systems is that pinpointing the location of the code transmitter in relation to the object can only be performed relatively imprecisely.

In a further known identification system (DE 199 57 536 A1) it is attempted to increase security against unauthorized use or unauthorized access resulting from monitoring of the challenge/response dialog by determining the distance of the code transmitter from the object and only code transmitters within a predefined range are accepted as authorized. However, the distance measurement may be incorrect if shadowing of the transmitted signals is present, thereby preventing or severely impeding direct communication between code transmitter and base station. In this case the distance measurement can additionally be combined with a position determination based on a triangulation measurement and the known level evaluation.

In another known identification system (DE 197 38 323 C1) the delay is measured between signals which run from the transmitters/receiver to the code transmitter or in the opposite direction. Similarly, the amplitude or the field strength of the received signals can be recorded in the vehicle-side receive unit in order to determine the position of the code transmitter.

### SUMMARY OF THE INVENTION

One object of the invention is to create an identification system which provides improved security against unauthorized use or unauthorized access. A further object of the invention is to determine the exact position of a code transmitter in relation to the object. Yet another object is to clearly differentiate between interior (inside the object) and exterior (outside the object) with regard to the location of the code transmitter.

These objects can be achieved according to the invention by an identification system for verifying an authorization for access to an object, or for the use of an object, in particular of a motor vehicle, comprising a mobile code transmitter which is carried by a user and which, when triggered, sends out a response signal containing code information specific to said code transmitter, an object-side receive unit which is connected to an evaluation unit in which the code information contained in a received response signal is compared with reference code information, and a distance measuring device and a level measuring device both disposed on the object side which determine the position of the code transmitter from the received response signal, wherein the level measuring device determines the field strength of a received response signal or the difference in field strengths of different received response signals and determines a distance between code transmitter and receive unit by comparison with reference values, and the evaluation unit has a weighting device which weights the measured levels and distances with weighting factors and determines therefrom the position of the responding code transmitter or of all the responding code transmitters.

These objects can furthermore be achieved by an identification system for verifying an authorization for access to an object, or for the use of an object, in particular of a motor vehicle, comprising a mobile code transmitter which is carried by a user and which, when triggered, sends out a response signal containing code information specific to said code transmitter, an object-side receive unit which is connected to an evaluation unit in which the code information contained in a received response signal is compared with reference code information, and a level measuring device disposed on the object side for determining the field strength of a received response signal or the difference in field strengths of different received response signals and by comparison with reference values for determining a distance between code transmitter and receive unit, and a weighting device within the evaluation unit which weights the measured levels and distances with weighting factors and determines therefrom the position of the responding code transmitter or of all the responding code transmitters.

The distance measuring device may determine the distance between code transmitter and receive unit by measuring the phase or delay of the response signal. A plurality of receive units can be disposed spatially separated from one another in the object and are each connected to a common evaluation unit, a level measurement and/or distance measurement being performed for each receive unit. There can be disposed in the object one or more transmit units which, when triggered, send out an interrogation signal, whereupon each code transmitter receiving an interrogation signal sends back a response signal. The object can be a motor vehicle and the security system can be a locking system or an immobilizer.

The objects can also be achieved by a method for verifying an authorization for access to an object, or for the use of an object, in particular of a motor vehicle, comprising the steps of:
sending out a response signal containing code information specific to a mobile code transmitter,
receiving the response signal in said object by a receive unit and comparing it with a reference code information, and
measuring distance and level within said object by determining the field strength of a received response signal or the difference in field strengths of different received response signals and determining a distance between code transmitter and receive unit by comparison with reference values, and
weighting the measured levels and distances with weighting factors and determining therefrom the position of the responding code transmitter or of all the responding code transmitters.

The method may further comprise the step of determining the distance between code transmitter and receive unit by measuring a phase or delay of the response signal. The object can be a motor vehicle and the security system can be a locking system or an immobilizer.

When it is triggered (e.g. on receiving an interrogation signal or by manual actuation of a trigger switch), at least one portable code transmitter sends out a response signal. The response signal contains code information which is specific to the code transmitter and by means of which the code transmitter verifies its authorization. In a receive unit disposed on the object side and an evaluation unit connected thereto, the code information contained in the received response signal is compared with reference code information. In addition, both the receive level of the response signal and the distance between code transmitter and receive unit is measured on the object side. From this, the position of the code transmitter relative to the object is determined. If, on the one hand, the code information matches the reference code information at least to a large extent and, on the other hand, the position of the code transmitter is detected as being within a specified range, an enabling signal for controlling a security system is generated.

Using this identification system the position of the code transmitter can be very precisely determined, irrespective of whether it is disposed inside the object (e.g. the motor vehicle) or even outside the object. Depending on the position, different security systems can then be controlled (e.g. the locking system or immobilizer of a motor vehicle).

Thus the distance measuring device can determine the distance between code transmitter and receive unit via a phase measurement or delay measurement of the signal duration of the response signal, i.e. the response signal itself being used to measure the distance. No distance measuring device separate from the challenge/response dialog is required. By means of reflected signals (so-called multipath propagation), a plurality of (in some cases even redundant) items of distance information are obtained which can be used for more precise position determination and also for differentiating between interior and exterior.

In addition to distance measurement, the level measuring device determines the receive level or the field strength of the received response signal. By comparing them with one or more predefined reference values (reference table), a distance between code transmitter and receive unit is therefore determined. This can be used for verifying the distance values obtained in the above-described distance measurement. For field strength measurement, current and/or voltage amplitudes can be measured in the receiver. For known transmission amplitude and known attenuation conditions as well as decay characteristics of the field strength, the distance can be determined by the ratio of the transmitted amplitude/field strength/level to the received amplitude/field strength of the electromagnetic field. Here too the response signal is used for the distance measurement. A separate signal is not required.

Advantageously a plurality of receive units are disposed spatially separated from one another in the object. Each receive unit can then be connected to a common evaluation unit. If the received level and the delay between code transmitter and the relevant receive unit is determined for at least two receive units, the position of the code transmitter can be determined more precisely. Triangulation methods can be used here, whereby the position can be determined more precisely or the previous measurement can be reliably verified.

Evaluation of the results can be performed in a receive unit and then notified to the evaluation unit or can even be performed in the central evaluation unit.

It is additionally very advantageous to dispose one or more transmit units in the object which send out an interrogation signal when triggered. In particular a simple reference can be obtained for the delay measurement if the transmit unit is connected to the evaluation unit. The time between transmission of the interrogation signal and receipt of the response signal is then used as the delay. No time information then needs to be transmitted as part of the response signal.

The signals need not be transmitted at different frequencies but can advantageously be transmitted at a single carrier frequency (which is also PTT-approved for the relevant application), preferably in the RF or microwave range.

It is also very advantageous to provide a plurality of receive units distributed around the object, thereby enabling the distance between code transmitter and receive unit and/or the response signal level to be measured by each receive unit. It is also possible for the distance to be measured by one receive unit and the level by the other receive unit.

If the evaluation unit has a weighting device which weights the measured levels and distances with weighting factors, the specific conditions at the object can be taken into account. For example, the levels at the receive units have a characteristic pattern when the code transmitter moves from the exterior to the interior. Likewise the distance measurements have a characteristic pattern (particularly if the distances are measured consecutively over time). This information can be transferred, for example, to a weighted level-distance matrix and used to decide whether or not the code transmitter is in the vehicle. Thus the distance and level information can be weighted differently depending on the location of the relevant receive device, in order to precisely determine the position of the code transmitter. If the measured values are entered in a weighted level-distance matrix, corresponding mathematical methods can be applied for further processing of the measured values in order to obtain the precise position of the code transmitter.

If the object to which access is requested or which the driver wishes to use is a motor vehicle, the security system will be a locking system or an immobilizer. Using position determination it is possible to determine precisely whether the position of the code transmitter is outside or inside the motor vehicle. Accordingly, different security systems can then be activated and therefore different functions can be initiated if code transmitter authorization is detected. Thus, for example, if the code transmitter is still far away, the interior light could be turned on together with unlocking of the doors (or the horn briefly sounded) to enable the motor vehicle to be found more easily in a parking lot or during the night. If, on the other hand, the code transmitter is detected in the motor vehicle, in addition to releasing the immobilizer, user-specific settings (such as seat or mirror adjustment) can also be performed.

With the precise position it is also possible to reliably distinguish as to whether the code transmitter is inside or outside the motor vehicle. Accordingly, in one case access can be enabled (locking or unlocking of the locking system) and in another case use can be enabled (release of the immobilizer) if authorization is detected.

The identification system is not exclusively limited to use in a motor vehicle. It can also be used for other objects such as personal computers, mobile telephones, smart cards or other devices for which authorization for access control or use is interrogated and the code transmitter is designed to be in close proximity to the object to allow authorization to be granted.

### BRIEF DESCRIPTION OF THE DRAWINGS

An exemplary embodiment of the invention will now be explained with reference to the schematic drawing in which:

FIG. 1 shows a block diagram of an identification system according to the invention, and

FIG. 2 shows an identification system according to FIG. 1 which is disposed in a motor vehicle.

### DETAILED DESCRIPTION OF THE PREFERRED EMBODIMENTS

An identification system for verifying an authorization for access to an object or for use of an object will now be explained in greater detail using the example of a motor vehicle as the object. The identification system can of course also be used for other objects to which access is only permitted after verification of said authentication, such as a computer, a telephone, an ATM, a building, garages or other initially locked areas.

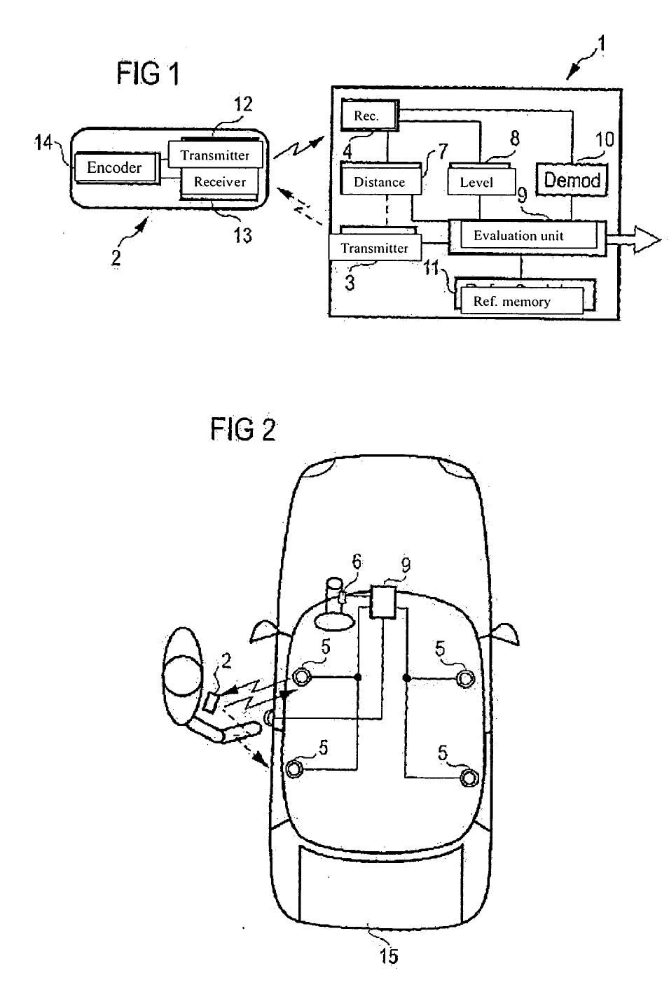

The identification system is here designed to conduct a bidirectional dialog (also known as challenge/response dialog) between a base station 1 (FIG. 1) containing a transceiver unit and a mobile, user-portable code transmitter 2 for verifying an authorization for access or use.

The object-side transceiver unit has at least one transmitter 3 and at least one receiver 4 which are each connected to receiving and/or transmitting antennas 5 via which signals can be transmitted and received. The antennas 5 are disposed at exposed positions in the motor vehicle (cf. FIG. 2), so that signals can be transmitted with sufficient field strength into the interior of the motor vehicle and into the vicinity of the motor vehicle and that signals can be sufficiently well received from there.

In the motor vehicle there are disposed security systems (not shown) such as door locks for access to the motor vehicle or an ignition/steering wheel lock 6 for an immobilizer for use of the motor vehicle. These are placed in a locked or unlocked state only when an authentication is verified with the aid of a coded enabling signal. In addition to verifying authorization, the code transmitter must actually be located in a particular specified position (or a tightly specified position range) in proximity to the motor vehicle or inside the motor vehicle, so that the appropriate actions/functions can be initiated.

According to the invention, both a distance measuring device 7 and a level measuring device 8 each connected to an evaluation unit 9 are required for precise position determination. To check the correct code information, a demodulator 10 is required which extracts the code information from the response signal and feeds it to the evaluation unit 9. The evaluation unit 9 compares the code information with reference code information stored in a reference memory 11. If they largely coincide, at least authorization is verified. If the position of the code transmitter 2—possibly still dependent on the operating state of the object based on the level and distance measurements—is then detected as being in a permissible position, corresponding functions or actions can be initiated in the object.

Each code transmitter 2 assigned to the object has a transmitter 12 and a receiver 13. The code transmitter 2 can receive signals (interrogation signals) and can transmit signals (response signals) in encoded form via the transmitter 12 using an encoder 14. It is generally used to transmit a coded response signal whose code information is used to verify authorization to access or use the object.

With the present identification system, authorization is only verified if, on the one hand, the base station 1 receives the correctly encoded response signal and the code information demodulated therefrom, and, on the other hand, the position of the code transmitter 2 is identified as being in a certain position in the vicinity of the motor vehicle or inside the motor vehicle.

For triggering the response signal, a switch in the region of an access door, for example, can be manually actuated (in FIG. 2 this is the driver's door). If the user brings his hand, for example, into close proximity to the door handle or touches/actuates said handle, an interrogation signal is triggered and sent out by the motor-vehicle-side transmitter 3. In addition, the interrogation signal can also be triggered by automatic detection of the position of the code transmitter 2 at a certain distance from the vehicle. If the code transmitter 2 receives the interrogation signal, it in turn sends out a response signal which is received by the vehicle-side receiver 4. Since in the exemplary embodiment the code transmitter 2 only sends out a response signal if it has first received an interrogation signal, it can also be termed a transponder.

On the one hand, the distance between code transmitter 2 and object is now determined (e.g. by measuring the signal delay of the response signal or the delay of the signals between transmission of the interrogation signal and reception of the response signal). This can take place by means of time measurement (possibly using timers both in the object and in the code transmitter 2) or via a phase measurement. In the case of time measurement, the signal delay is measured indirectly or directly and the distance for a known signal propagation rate is determined. For the phase measurement, the change in phase compared to the transmitted phase is measured. The phase shift for a known propagation rate of the signal is a measure for the distance traveled.

It is advantageous if the transmission instant or the phase of the interrogation signal is taken into account for determining the distance (dashed line connecting “transmitter” and “distance” blocks in FIG. 1).

Measuring the delay of a signal or of a path traveled by a signal will be sufficiently well known e.g. also from radar principles (FM-CW radar) to the average person skilled in the art. No more detailed explanations will therefore be given here.

On the other hand, the level/amplitude/field strength of the received signal is determined. If the level with which the response signal is transmitted is known, it is possible to calculate, on the basis of the known transmission loss and the transmission media, how far away the transmitter 2 is located. For measuring the level, a current or voltage measurement can be performed on the received signal. In addition, certain level-distance patterns resulting from the “movement” of the code transmitter 2 carried on the user's person can be observed which can be used for verifying the distances measured.

If the code transmitter 2 is supplied with energy from its own power source (battery), service life can also be taken into account for the level measurement, as the battery's voltage diminishes with time and therefore the transmitted level is increasingly reduced with time. In the evaluation unit 9 the measured level should then be provided with a time correction factor which takes into account the level reduction over time.

For the level measurement, the absolute level can be used as a measured variable. It is likewise possible to perform a relative level measurement in which the measured level is placed in relation to a previously measured level and only the difference is used as the measured variable. For the relative level measurement, the levels of signals received via different antennas 5 can also be measured. These measured levels can be placed in relation to one another (i.e. taking the difference). For example, the levels of signals received by so-called exterior antennas (disposed outside the motor vehicle) can be measured and placed in relation to levels from signals received by so-called interior antennas (disposed inside the motor vehicle). From the difference between the two levels, the distance can be determined or the position of the code transmitter 2 can be differentiated between exterior and interior.

The position of the code transmitter 2 can be determined even more precisely if a plurality of receivers 4 disposed in a distributed manner in or on the object each receive the response signal. The position can then be spatially determined using geometrical means (e.g. triangulation) and level measurement.

It is in any case advantageous to dispose a plurality of receivers 4 in the object. Also movement of the code transmitter 2 or the side from which the object is being approached by the code transmitter 2 could be detected in this way. Depending on the position-code information having been authenticated—appropriate actions can then be initiated. Thus, for example—if the trunk 15 is being approached—the rear hood can first be unlocked and if necessary opened. After a time period one or more of the door locks can then be unlocked.

1. An identification system for verifying an authorization for access to an object, or for the use of an object, in particular of a motor vehicle, comprising:
a mobile code transmitter which is carried by a user and which, when triggered, sends out a response signal containing code information specific to said code transmitter,
an object-side receive unit which is connected to an evaluation unit in which the code information contained in a received response signal is compared with reference code information, and
a distance measuring device and a level measuring device both disposed on the object side which determine the position of the code transmitter from the received response signal,
wherein
the level measuring device determines the field strength of a received response signal or the difference in field strengths of different received response signals and determines a distance between code transmitter and receive unit by comparison with reference values, and
the evaluation unit has a weighting device which weights the measured levels and distances with weighting factors and determines therefrom the position of the responding code transmitter or of all the responding code transmitters.

2. The identification system according to claim 1, wherein the distance measuring device determines the distance between code transmitter and receive unit by measuring the phase or delay of the response signal.

3. The identification system according to claim 1, wherein a plurality of receive units are disposed spatially separated from one another in the object and are each connected to a common evaluation unit, a level measurement and/or distance measurement being performed for each receive unit.

4. The identification system according to claim 1, wherein there are disposed in the object one or more transmit units which, when triggered, send out an interrogation signal, whereupon each code transmitter receiving an interrogation signal sends back a response signal.

5. The identification system according to claim 1, wherein the object is a motor vehicle and the security system is a locking system or an immobilizer.

6. An identification system for verifying an authorization for access to an object, or for the use of an object, in particular of a motor vehicle, comprising:
a mobile code transmitter which is carried by a user and which, when triggered, sends out a response signal containing code information specific to said code transmitter,
an object-side receive unit which is connected to an evaluation unit in which the code information contained in a received response signal is compared with reference code information,
a level measuring device disposed on the object side for determining the field strength of a received response signal or the difference in field strengths of different received response signals and by comparison with reference values for determining a distance between code transmitter and receive unit, and
a weighting device within the evaluation unit which weights the measured levels and distances with weighting factors and determines therefrom the position of the responding code transmitter or of all the responding code transmitters.

7. The identification system according to claim 6, wherein the distance measuring device determines the distance between code transmitter and receive unit by measuring the phase or delay of the response signal.

8. The identification system according to claim 6, wherein a plurality of receive units are disposed spatially separated from one another in the object and are each connected to a common evaluation unit, a level measurement and/or distance measurement being performed for each receive unit.

9. The identification system according to claim 6, wherein there are disposed in the object one or more transmit units which, when triggered, send out an interrogation signal, whereupon each code transmitter receiving an interrogation signal sends back a response signal.

10. The identification system according to claim 6, wherein the object is a motor vehicle and the security system is a locking system or an immobilizer.

11. A method for verifying an authorization for access to an object, or for the use of an object, in particular of a motor vehicle, comprising the steps of:
sending out a response signal containing code information specific to a mobile code transmitter,
receiving the response signal in said object by a receive unit and comparing it with a reference code information,
measuring distance and level within said object by determining the field strength of a received response signal or the difference in field strengths of different received response signals and determining a distance between code transmitter and receive unit by comparison with reference values, and
weighting the measured levels and distances with weighting factors and detenmining therefrom the position of the responding code transmitter or of all the responding code transmitters.

12. The method according to claim 11, further comprising the step of determining the distance between code transmitter and receive unit by measuring a phase or delay of the response signal.

13. The method according to claim 1, wherein the object is a motor vehicle and the security system is a locking system or an immobilizer.
